(19) United States
(12) Patent Application Publication
(10) Pub. No.: US 2026/0205654 A1
(43) Pub. Date: Jul. 16, 2026

(54) MULTI-DISPLAY SYSTEM, MASTER ELECTRONIC DEVICE, SLAVE ELECTRONIC DEVICE, AND DISPLAY METHOD

(71) Applicant: SHARP DISPLAY SOLUTIONS, LTD., Tokyo (JP)

(72) Inventor: Hiroshi SUNAGARE, Tokyo (JP)

(21) Appl. No.: 19/557,785

(22) Filed: Mar. 5, 2026

Related U.S. Application Data
(63) Continuation of application No. PCT/JP2023/034504, filed on Sep. 22, 2023.

(51) Int. Cl. H04N 21/439

(52) U.S. Cl. CPC H04N 21/4396

(57) ABSTRACT

If a discrimination result is received from a first electronic device, a slave electronic device performs a configurating process according to a type of video signal in accordance with the discrimination result with respect to each device related to a video display process based on a video signal within the slave electronic device without performing a discrimination process of discriminating the video signal input to the slave electronic device. A master electronic device, which is the first electronic device, makes the determination of whether or not there has been a change in a video signal input to the master electronic device earlier than the determination of whether or not there has been a change in a video signal input to the slave electronic device without determining whether a mute notification has been received from any electronic device other than the first electronic device, discriminates the video signal input to the master electronic device, notifies each electronic device other than the master electronic device of the discrimination result and a mute instruction, and performs a configurating process according to a type of the video signal according to the discrimination result. When all device configurating processes of the respective electronic devices are completed, each electronic device performs a video unmuting process and displays a video.

### TECHNICAL FIELD

The present invention relates to a multi-display system, a master electronic device, a slave electronic device, and a display method.

### BACKGROUND ART

In a multi-display system, a plurality of display areas are arranged adjacent to each other in vertical and horizontal directions and each of a plurality of electronic devices (e.g., projectors) projects a video based on a video signal onto a projection target display area. Thereby, it is possible to display a single display screen by projecting a video onto each display area (see, for example, Patent Document 1).

In this multi-display system, timings at which video signals are input to the respective projectors do not necessarily match. Therefore, when each projector projects a video based on each video signal, the timing at which the video starts to be displayed differs in each display area. As a result, because the videos start to be displayed separately in the respective display areas, the videos in the respective display areas are not displayed simultaneously and a sense of discomfort is caused for a user viewing the display screen.

In such a multi-display system, when video signals are input to the plurality of projectors, each projector mutes a display of a video based on the video signal and performs a video display unmuting process after performing a configurating process for performing a display based on the video signal. Thereby, a display process can be performed so that display timings of videos projected by the plurality of projectors are consistent.

### Citation List

### Patent Document

Patent Document 1: Japanese Unexamined Patent Application, First Publication No. 2005-274937

### SUMMARY OF INVENTION

### Technical Problem

However, there is a problem because a length of time between the supply of a video signal to each electronic device and the display of a video on a display screen increases.

### Solution to Problem

According to an aspect of the present invention, there is provided a multi-display system including a plurality of electronic devices for displaying videos based on video signals, wherein the plurality of electronic devices are first to N^{th} electronic devices, where N is a natural number of 2 or more, and a video signal is supplied to each electronic device, wherein a slave electronic device other than the first electronic device includes a mute notification determiner configured to determine whether or not a mute notification for muting a display of a video based on the video signal has been received from any electronic device other than the first electronic device; a mute processor configured to perform a video muting process in accordance with the reception of the mute notification from any electronic device other than its own electronic device; a discrimination result determiner configured to determine whether or not a discrimination result of discriminating the video signal has been received from any electronic device other than its own electronic device; a second device configurator configured to perform a configurating process according to a type of the video signal in accordance with the discrimination result received from the first electronic device with respect to each device related to a video display process based on the video signal within its own electronic device without performing a discrimination process of discriminating the video signal input to its own electronic device by receiving the discrimination result from the first electronic device among electronic devices other than its own electronic device; a second configurating completion notifier configured to transmit a notification notifying that the configurating process has been completed to each electronic device other than its own electronic device if a device configurating process ends; and a second unmuter configured to receive the notification notifying that the configurating process has been completed from each electronic device, perform a video unmuting process of its own electronic device when all device configurating processes of the plurality of electronic devices including its own electronic device have been completed, and cause a display device to display a video based on the video signal, and wherein a master electronic device that is the first electronic device includes a signal change determiner configured to determine whether or not a video signal input to its own electronic device has changed without determining whether or not a mute notification for muting a display of a video based on a video signal has been received from any electronic device other than its own electronic device; a discriminator configured to discriminate the video signal input to its own electronic device after it is determined that there has been a change in the video signal on the basis of a determination result of the signal change determiner; a notifier configured to notify each electronic device other than its own electronic device of a discrimination result and a mute instruction to mute the display of the video based on the video signal when the discriminator has discriminated the video signal; a first muter configured to mute a display of a video based on a video signal of its own electronic device in accordance with the discrimination of the video signal by the discriminator; a first device configurator configured to perform a configurating process according to a type of the video signal in accordance with the discrimination result with respect to each device related to a video display process based on the video signal within its own electronic device on the basis of a discrimination result when the discriminator obtains the discrimination result; a first configurating completion notifier configured to transmit a notification notifying that a configurating process has been completed to each electronic device other than its own electronic device if a device configurating process ends; and a first unmuter configured to receive the notification notifying that the configurating process has been completed from each electronic device, perform a video unmuting process of its own electronic device when all device configurating processes of the plurality of electronic devices including its own electronic device have been completed, and cause a display device to display a video based on the video signal.

Moreover, according to an aspect of the present invention, there is provided a slave electronic device for use in a multi-display system including a plurality of electronic devices for displaying videos based on video signals, wherein the plurality of electronic devices are first to N^{th} electronic devices, where N is a natural number of 2 or more, and a video signal is supplied to each electronic device, and wherein the slave electronic device other than the first electronic device includes a mute notification determiner configured to determine whether or not a mute notification for muting a display of a video based on the video signal has been received from any electronic device other than the first electronic device; a mute processor configured to perform a video muting process in accordance with the reception of the mute notification from any electronic device other than its own electronic device; a discrimination result determiner configured to determine whether or not a discrimination result of discriminating the video signal has been received from any electronic device other than its own electronic device; a second device configurator configured to perform a configurating process according to a type of the video signal in accordance with the discrimination result received from the first electronic device with respect to each device related to a video display process based on the video signal within its own slave electronic device without performing a discrimination process of discriminating the video signal input to its own slave electronic device by receiving the discrimination result from the first electronic device among electronic devices other than its own electronic device; a second configurating completion notifier configured to transmit a notification notifying that the configurating process has been completed to each electronic device other than its own electronic device if a device configurating process ends; and a second unmuter configured to receive the notification notifying that the configurating process has been completed from each electronic device, perform a video unmuting process of its own slave electronic device when all device configurating processes of the plurality of electronic devices including its own slave electronic device have been completed, and cause a display device to display a video based on the video signal.

Moreover, according to an aspect of the present invention, there is provided a master electronic device for use in a multi-display system including a plurality of electronic devices for displaying videos based on video signals, wherein the plurality of electronic devices are first to N^{th} electronic devices, where N is a natural number of 2 or more, and a video signal is supplied to each electronic device, and wherein the master electronic device that is the first electronic device includes a signal change determiner configured to determine whether or not a video signal input to its own master electronic device has changed without determining whether or not a mute notification for muting a display of a video based on a video signal has been received from any electronic device other than its own electronic device; a discriminator configured to discriminate the video signal input to its own master electronic device after it is determined that there has been a change in the video signal on the basis of a determination result of the signal change determiner; a notifier configured to notify each electronic device other than its own electronic device of a discrimination result and a mute instruction to mute the display of the video based on the video signal when the discriminator has discriminated the video signal; a first muter configured to mute a display of a video based on a video signal of its own master electronic device in accordance with the discrimination of the video signal by the discriminator; a first device configurator configured to perform a configurating process according to a type of the video signal in accordance with the discrimination result with respect to each device related to a video display process based on the video signal within its own master electronic device on the basis of a discrimination result when the discriminator obtains the discrimination result; a first configurating completion notifier configured to transmit a notification notifying that a configurating process has been completed to each electronic device other than its own electronic device if a device configurating process ends; and a first unmuter configured to receive the notification notifying that the configurating process has been completed from each electronic device, perform a video unmuting process of its own master electronic device when all device configurating processes of the plurality of electronic devices including its own master electronic device have been completed, and cause a display device to display a video based on the video signal.

Moreover, according to an aspect of the present invention, there is provided a display method in a multi-display system including a plurality of electronic devices for displaying videos based on video signals, wherein the plurality of electronic devices are first to N^{th} electronic devices, where N is a natural number of 2 or more, and a video signal is supplied to each electronic device, wherein, in a slave electronic device other than the first electronic device, a mute notification determiner determines whether or not a mute notification for muting a display of a video based on the video signal has been received from any electronic device other than the first electronic device; a mute processor performs a video muting process in accordance with the reception of the mute notification from any electronic device other than its own electronic device; a discrimination result determiner determines whether or not a discrimination result of discriminating the video signal has been received from any electronic device other than its own electronic device; a second device configurator performs a configurating process according to a type of the video signal in accordance with the discrimination result received from the first electronic device with respect to each device related to a video display process based on the video signal within its own electronic device without performing a discrimination process of discriminating the video signal input to its own electronic device by receiving the discrimination result from the first electronic device among electronic devices other than its own electronic device; a second configurating completion notifier transmits a notification notifying that the configurating process has been completed to each electronic device other than its own electronic device if a device configurating process ends; and a second unmuter receives the notification notifying that the configurating process has been completed from each electronic device, performs a video unmuting process of its own electronic device when all device configurating processes of the plurality of electronic devices including its own electronic device have been completed, and causes a display device to display a video based on the video signal, and wherein, in a master electronic device that is the first electronic device, a signal change determiner makes the determination of whether or not there has been a change in a video signal input to its own electronic device earlier than the determination of whether or not there has been a change in a video signal input to the slave electronic device without determining whether or not a mute notification for muting a display of a video based on a video signal has been received from any electronic device other than its own electronic device; a discriminator discriminates the video signal input to its own electronic device after it is determined that there has been a change in the video signal on the basis of a determination result of the signal change determiner; a notifier notifies each electronic device other than its own electronic device of a discrimination result and a mute instruction to mute the display of the video based on the video signal when the discriminator has discriminated the video signal; a first muter mutes a display of a video based on a video signal of its own electronic device in accordance with the discrimination of the video signal by the discriminator; a first device configurator performs a configurating process according to a type of the video signal in accordance with the discrimination result with respect to each device related to a video display process based on the video signal within its own electronic device on the basis of a discrimination result when the discriminator obtains the discrimination result; a first configurating completion notifier transmits a notification notifying that a configurating process has been completed to each electronic device other than its own electronic device if a device configurating process ends; and a first unmuter receives the notification notifying that the configurating process has been completed from each electronic device, performs a video unmuting process of its own electronic device when all device configurating processes of the plurality of electronic devices including its own electronic device have been completed, and causes a display device to display a video based on the video signal.

Moreover, according to an aspect of the present invention, there is provided a display method in a multi-display system including a plurality of electronic devices for displaying videos based on video signals, wherein the plurality of electronic devices are first to N^{th} electronic devices, where N is a natural number of 2 or more, and a video signal is supplied to each electronic device, and wherein, in a slave electronic device other than the first electronic device, a mute notification determiner determines whether or not a mute notification for muting a display of a video based on the video signal has been received from any electronic device other than the first electronic device; a mute processor performs a video muting process in accordance with the reception of the mute notification from any electronic device other than its own electronic device; a discrimination result determiner determines whether or not a discrimination result of discriminating the video signal has been received from any electronic device other than its own electronic device; a second device configurator performs a configurating process according to a type of the video signal in accordance with the discrimination result received from the first electronic device with respect to each device related to a video display process based on the video signal within its own slave electronic device without performing a discrimination process of discriminating the video signal input to its own slave electronic device by receiving the discrimination result from the first electronic device among electronic devices other than its own electronic device; a second configurating completion notifier transmits a notification notifying that the configurating process has been completed to each electronic device other than its own electronic device if a device configurating process ends; and a second unmuter receives the notification notifying that the configurating process has been completed from each electronic device, performs a video unmuting process of its own slave electronic device when all device configurating processes of the plurality of electronic devices including its own slave electronic device have been completed, and causes a display device to display a video based on the video signal.

Moreover, according to an aspect of the present invention, there is provided a display method in a multi-display system including a plurality of electronic devices for displaying videos based on video signals, wherein the plurality of electronic devices are first to N^{th} electronic devices, where N is a natural number of 2 or more, and a video signal is supplied to each electronic device, and wherein, in a master electronic device that is the first electronic device, a signal change determiner makes the determination of whether or not there has been a change in a video signal input to its own master electronic device earlier than the determination of whether or not there has been a change in a video signal input to an electronic device other than the master electronic device without determining whether or not a mute notification for muting a display of a video based on a video signal has been received from any electronic device other than its own electronic device; a discriminator discriminates the video signal input to its own master electronic device after it is determined that there has been a change in the video signal on the basis of a determination result of the signal change determiner; a notifier notifies each electronic device other than its own electronic device of a discrimination result and a mute instruction to mute the display of the video based on the video signal when the discriminator has discriminated the video signal; a first muter mutes a display of a video based on a video signal of its own master electronic device in accordance with the discrimination of the video signal by the discriminator; a first device configurator performs a configurating process according to a type of the video signal in accordance with the discrimination result with respect to each device related to a video display process based on the video signal within its own master electronic device on the basis of a discrimination result when the discriminator obtains the discrimination result; a first configurating completion notifier transmits a notification notifying that a configurating process has been completed to each electronic device other than its own electronic device if a device configurating process ends; and a first unmuter receives the notification notifying that the configurating process has been completed from each electronic device, performs a video unmuting process of its own master electronic device when all device configurating processes of the plurality of electronic devices including its own master electronic device have been completed, and causes a display device to display a video based on the video signal.

### Advantageous Effects of Invention

It is possible to reduce an increase in a length of time between the supply of a video signal to each electronic device and the display of a video on a display screen.

### BRIEF DESCRIPTION OF DRAWINGS

FIG. 1 A schematic diagram showing a configuration of a multi-display system S according to a first embodiment.

FIG. 2 An explanatory schematic functional block diagram of functions of a projector 110.

FIG. 3 A diagram showing an example of a signal table.

FIG. 4 An explanatory flowchart of an operation of the projector 110.

FIG. 5 A diagram showing states of mute flags of projectors 110 to 113.

FIG. 6 A schematic diagram showing a configuration of a multi-display system Sa according to a second embodiment.

FIG. 7 A schematic diagram showing a configuration of a multi-display system Sb according to a third embodiment.

### DESCRIPTION OF EMBODIMENTS

Hereinafter, a multi-display system according to an embodiment of the present invention will be described with reference to the drawings.

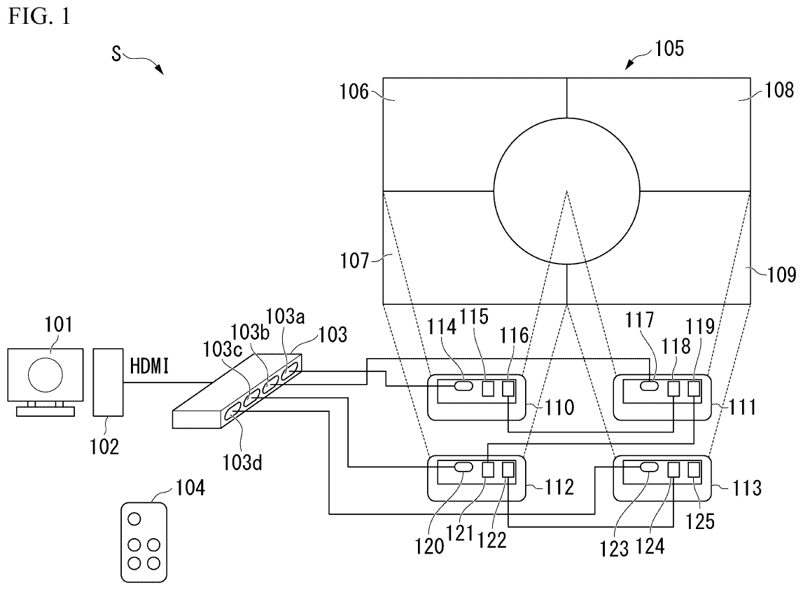

FIG. 1 is a schematic configuration diagram showing a configuration of a multi-display system S according to a first embodiment.

The multi-display system S includes a plurality of electronic devices configured to display videos based on video signals. The electronic devices are, for example, projectors.

The display device 101 is connected to a video signal supply device 102 via a communication cable. The display device 101 is used as a monitor for the video signal supply device 102.

The video signal supply device 102 is connected to the display device 101 via a communication cable and is also connected to the distributor 103 via a communication cable.

The video signal supply device 102 outputs a video signal according to the content to the distributor 103 via the communication cable. This communication cable may be, for example, a high-definition multimedia interface (HDMI (registered trademark)) cable.

Moreover, the video signal supply device 102 also outputs a video signal and various types of information to the display device 101. The video signal supply device 102 is, for example, a computer.

The distributor 103 is connected to the video signal supply device 102 via the communication cable. Moreover, the distributor 103 is connected to a projector 110, a projector 111, a projector 112, and a projector 113 via different communication cables. The communication cable used to connect the distributor 103 to each projector may be, for example, the HDMI (registered trademark) cable.

The distributor 103 has a first terminal 103a, a second terminal 103b, a third terminal 103c, and a fourth terminal 103d. The first terminal 103a is connected to an input terminal 114 of the projector 110 via the communication cable. The second terminal 103b is connected to an input terminal 117 of the projector 111 via the communication cable. The third terminal 103c is connected to an input terminal 120 of the projector 112 via the communication cable. The fourth terminal 103d is connected to an input terminal 123 of the projector 113 via the communication cable.

The distributor 103 supplies video signals output from the video signal supply device 102 to the projector 110, the projector 111, the projector 112, and the projector 113. In other words, the distributor 103 distributes the video signals output from the video signal supply device 102 to the four projectors.

A remote controller 104 wirelessly transmits a control signal and a switching signal to each of the projectors (the projector 110, the projector 111, the projector 112, and the projector 113). The control signal is a signal that turns on or off a power supply. A switching signal is a signal for switching the device from which the video signal is input.

A screen 105 displays videos by projecting the videos from the projectors (the projector 110, the projector 111, the projector 112, and the projector 113).

The screen 105 is divided into a plurality of display areas (video display areas). Here, the screen 105 is divided into two display areas in a vertical direction and two display areas in a horizontal direction, such that the screen 105 is divided into a total of four display areas, i.e., the display area 106, the display area 107, the display area 108, and the display area 109. The display area 106, the display area 107, the display area 108, and the display area 109 are installed adjacent to each other.

The display area 106 is assigned as an area onto which a video is projected by the projector 110. The display area 107 is assigned as an area onto which a video is projected by the projector 112. The display area 108 is assigned as an area onto which a video is projected by the projector 111. The display area 109 is assigned as an area onto which a video is projected by the projector 113.

The projector 110 inputs the video signal supplied from the video signal supply device 10 via the distributor 103 and projects a video based on the input video signal onto the display area 106.

The projector 110 has the input terminal 114, the input terminal 115, and the output terminal 116.

The input terminal 114 is connected to the first terminal 103a of the distributor 103 via the communications cable (the HDMI (registered trademark) cable) and inputs the video signal.

The input terminal 115 is an input terminal capable of inputting a signal based on HDBaseT that is a communications standard. The input terminal 115 is not connected to other electronic devices (the projector 111, the projector 12, and the projector 112).

The output terminal 116 is an output terminal capable of outputting a signal based on HDBaseT.

The projector 110 enlarges a video corresponding to an upper left area among two segment areas in the vertical direction and two segment areas in the horizontal direction based on the video signal input from the input terminal 114 and projects the video onto the display area 106 of the screen 105. In this case the projector 110 does not perform any projection process by discarding an upper right area, a lower left area, and a lower right area among the segment areas.

The projector 111 inputs the video signal supplied from the video signal supply device 10 via the distributor 103 and projects the video based on the input video signal onto the display area 108.

The projector 111 has an input terminal 117, an input terminal 118, and an output terminal 119.

The input terminal 117 is connected to the second terminal 103b of the distributor 103 via the communication cable (the HDMI (registered trademark) cable) and inputs the video signal.

The input terminal 118 is an input terminal to which a signal based on HDBaseT that is the communication standard can be input. The input terminal 118 is connected to the output terminal 116 of the projector 110 via the communication cable (e.g., a local area network (LAN) cable) through which signals based on HDBaseT can be communicated.

The output terminal 119 is an output terminal capable of outputting signals based on HDBaseT.

The projector 111 enlarges a video corresponding to the upper right area among the two segment areas in the vertical direction and the two segment areas in the horizontal direction based on the video signal input from the input terminal 117 and projects the video onto the display area 108 of the screen 105. In this caconfiguratehe projector 111 does not perform any projection process by discarding the upper left area, the lower left area, and the lower right area among the segment areas.

The projector 112 inputs the video signal supplied from the video signal supply device 10 via the distributor 103 and projects the video based on the input video signal onto the display area 107.

The projector 112 has an input terminal 120, an input terminal 121, and an output terminal 122.

The input terminal 120 is connected to the third terminal 103c of the distributor 103 via the communications cable (the HDMI (registered trademark) cable) and inputs a video signal.

The input terminal 121 is an input terminal capable of inputting a signal based on HDBaseT that is the communications standard. The input terminal 121 is connected to the output terminal 119 of the projector 111 via the communications cable (e.g., a LAN cable) through which signals based on HDBaseT can be communicated.

The output terminal 122 is an output terminal capable of outputting a signal based on HDBaseT.

The projector 112 enlarges a video corresponding to the lower left area among the two segment areas in the vertical direction and the two segment areas in the horizontal direction based on the video signal input from the input terminal 120 and projects the video onto the display area 107 of the screen 105. In this case the projector 112 does not perform any projection process by discarding the upper left area, the upper right area, and the lower right area among the segment areas.

The projector 113 inputs a video signal supplied from the video signal supply device 10 via the distributor 103 and projects a video based on the input video signal onto the display area 109.

The projector 113 has an input terminal 123, an input terminal 124, and an output terminal 125.

The input terminal 123 is connected to the fourth terminal 103d of the distributor 103 via the communication cable (the HDMI (registered trademark) cable) and inputs a video signal.

The input terminal 124 is an input terminal that can input a signal based on HDBaseT that is a communication standard. The input terminal 124 is connected to the output terminal 122 of the projector 112 via the communication cable (e.g., a LAN cable) through which signals based on HDBaseT can be communicated.

The output terminal 125 is an output terminal capable of outputting a signal based on HDBaseT. Here, in the present embodiment, the number of projectors connected to the distributor 103 is four, any other projector is not connected to a stage subsequent to the output terminal 125. When the multi-display system S is configured to include five or more projectors, the output terminal 125 is connected to an input terminal capable of inputting a signal based on HDBaseT of the projector of a subsequent stage.

The projector 113 enlarges a video corresponding to the lower right area among the two segment areas in the vertical direction and the two segment areas in the horizontal direction based on the video signal input from the input terminal 123 and projects the video onto the display area 109 of the screen 105. In this case the projector 112 does not perform any projection process by discarding the upper left area, the upper right area, and the lower left area among the segment areas.

The multi-display system S has such a configuration and can project a video based on the video signal supplied from the video signal supply device 102 onto the screen 105.

When a video is projected to fit the size of the screen 105 using only one projector, the brightness of the projected video may be less than target brightness. The above-described multi-display system S projects a video onto the screen 105 using four projectors. Therefore, it is possible to project a video to fit the size of the screen 105 while ensuring the target brightness.

Here, the distributor 103 acquires extended display identification data (EDID) information of the projector 110 from the projector 110 via the communication cable connected to the first terminal 103a and outputs a video signal according to the optimal resolution of the projector 110 to the projector 110. The distributor 103 acquires the EDID information of the projector 111 from the projector 111 using the second terminal 103b and outputs a video signal according to the optimal resolution of the projector 111 to the projector 111. The distributor 103 acquires EDID information of the projector 112 from the projector 112 through the third terminal 103c and outputs a video signal according to the optimal resolution of the projector 112 to the projector 112. The distributor 103 acquires EDID information of the projector 112 from the projector 112 through the fourth terminal 103d and outputs a video signal according to the optimal resolution of the projector 112 to the projector 112.

This EDID information acquisition is performed in the order of the projector 110, the projector 111, the projector 112, and the projector 113. Therefore, the video signals output from the first terminal 103a, the second terminal 103b, the third terminal 103c, and the fourth terminal 103d of the distributor 103 are not output simultaneously, but an output process starts in the order of the first terminal 103a, the second terminal 103b, the third terminal 103c, and the fourth terminal 103d.

Moreover, in the above-described multi-display system S, each projector is connected by the communication cable (e.g., the LAN cable) according to HDBaseT. In this case, for example, each projector can receive a video signal transmitted via the HDMI (registered trademark) cable and exchange commands between the devices via the LAN cable.

Moreover, in the present embodiment, in the case of communication via a LAN cable, each projector only transmits commands on the basis of an HDBaseT standard and the transmission of video signals is not performed between the projectors. For example, in the case of the transmission and reception of commands between the projectors like the transmission of a command from the projector 110 to the projector 113, the transmission of a command from the projector 112 to the projector 110, or the like, communication can be performed via the LAN cable. In this case, the respective projectors can transmit and receive commands to and from each other as if they are connected to each other via a router.

Moreover, it is previously configured whether or not the projector is a first projector (a first electronic device) among a plurality of projectors (110, 111, 112, and 113). For example, it is only necessary for the first projector to be a projector that performs a video signal input process earlier than a video signal input process to be performed by at least one other projector among the plurality of projectors (110, 111, 112, and 113). Moreover, preferably, the first projector is a projector to which a video signal is first input, because a length of time between the supply of a video signal and the display of a video on the display screen cannot increase.

In the multi-display system S, numbers are assigned in advance to the first terminal 103a, the second terminal 103b, the third terminal 103c, and the fourth terminal 103d, which are the output terminals of the distributor 103. Each projector (110, 111, 112, or 113) recognizes any one of the first terminal 103a, the second terminal 103b, the third terminal 103c, and the fourth terminal 103d of the distributor 103 connected thereto and identifies whether the projector is a first projector (a first electronic device) or a second or subsequent projector (a second electronic device, a third electronic device, or a fourth electronic device). For example, the number 1 is assigned to the first terminal 103a and any one of the numbers 2, 3, and 4 is assigned to the second terminal 103b, the third terminal 103c, or the fourth terminal 103d.

Each projector (110, 111, 112, or 113) can identify whether or not it is the first projector by identifying the assigned number and can determine whether a projection target display area is the display area 106, the display area 107, the display area 108, or the display area 109.

In the present embodiment, the projector 110 is connected to the first terminal 103a and functions as the first projector (hereinafter also referred to as a master projector). The projector 111 is connected to the second terminal 103b, the projector 112 is connected to the third terminal 103c, and the projector 113 is connected to the fourth terminal 103d, and the projectors 111, 112, and 113 function as projectors (hereinafter also referred to as slave projectors) other than the first project.

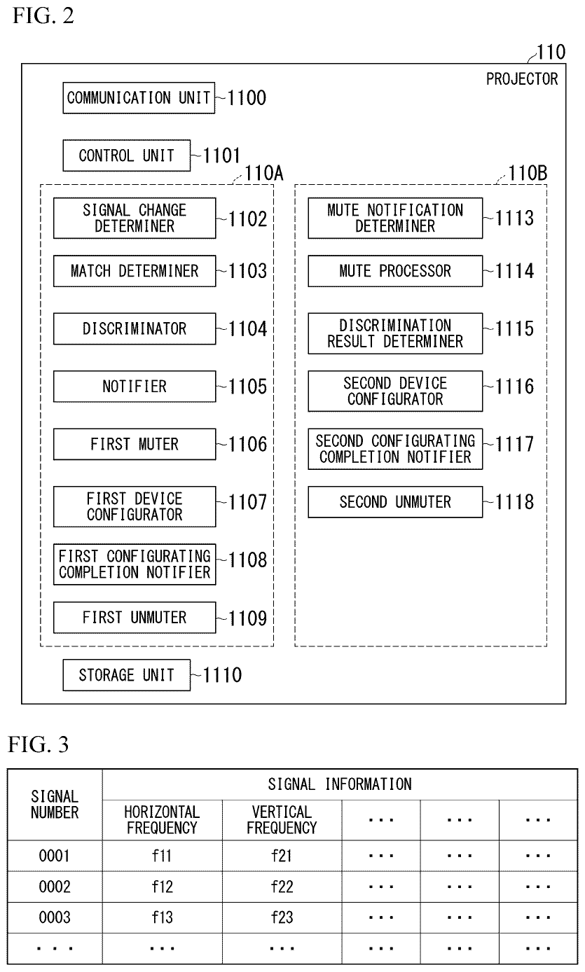

FIG. 2 is an explanatory schematic functional block diagram of the functions of the projector 110. Although the functions of the projector 110 will be described with reference to FIG. 2, the projectors 111, 112, and 113 have functions identical to those of the projector 110 shown in FIG. 2.

In FIG. 2, the projector 110 has a communication unit 1100, a control unit 1101, a first functional unit 110A, a second functional unit 110B, and a storage unit 1110.

The communication unit 1100 communicates with external devices (e.g., the video signal supply device 102) via the HDMI (registered trademark) cable. The communication unit 1100 also communicates with an external device (e.g., a projector) via the LAN cable.

The control unit 1101 controls each part within the projector. For example, the control unit 1101 determines whether or not its own projector is the first projector and causes either the first functional unit 110A or the second functional unit 110B to execute a process on the basis of a determination result.

The control unit 1101 causes the first functional unit 110A to execute a process when its own projector is the first projector and causes the second functional unit 110B to execute a process when its own projector is not the first projector.

The first functional unit 110A has a function for operating as the first projector when it is determined that its own projector is the first projector.

The second functional unit 110B has a function for operating as a projector other than the first projector when it is determined that its own projector is a projector other than the first projector.

The first functional unit 110A has a signal change determiner 1102, a match determiner 1103, a discriminator 1104, a notifier 1105, a first muter 1106, a first device configurator 1107, a first configurating completion notifier 1108, and a first unmuter 1109.

The signal change determiner 1102 determines whether or not the video signal input to its own electronic device has changed (e.g., step S405 to be described below) without determining whether or not a mute notification for muting the display of the video based on the video signal has been received from any electronic device other than its own electronic device (e.g., step S402 to be described below). The signal change determiner 1102 can make the determination of whether or not there has been a change in the video signal input to its own electronic device earlier than the determination of whether or not there has been a change in the video signal input to the slave projector.

Here, the signal change determiner 1102 analyzes the video signal and obtains signal information, which is information about the video signal, on the basis of an analysis result. The signal information includes, for example, at least one of the presence or absence of a video signal, a horizontal frequency, a vertical frequency, horizontal signal polarity, vertical signal polarity, horizontal resolution, vertical resolution, the total number of horizontal dots, the number of vertical lines, InfoFrame information, and the like.

The signal change determiner 1102 determines whether or not there has been a change in the video signal on the basis of whether or not there has been a change in the signal information. For example, the signal change determiner 1102 determines that there is a change in the video signal when there has been a change in the signal information obtained by analyzing the video signal. The signal change determiner 1102 determines that there is no change in the video signal when there is no change in the signal information.

The signal change determiner 1102, for example, determines whether or not the signal information obtained by the previous analysis matches the signal information obtained by the current analysis, determines that there is no change in the video signal when the previous signal information matches the current signal information, and determines that there is a change in the video signal when the previous signal information does not match the current signal information.

Examples of cases in which it is determined that there is a change in the video signal include a case where any item value included in the signal information has changed or a case where the state of the video signal indicated by any item is different like a case where the state has changed from a state in which there is no video signal to a state in which there is a video signal, a case where there has been a change in the horizontal frequency, a case where there has been a change in the vertical signal polarity, or the like.

The match determiner 1103 determines whether or not the signal information has matched multiple times after it is determined that there has been a change in the video signal on the basis of a determination result of the signal change determiner 1102. For example, the match determiner 1103 may find that the horizontal frequency obtained as an analysis result at a first timing does not match the horizontal frequency obtained as an analysis result at a subsequent second timing and the horizontal frequency obtained as an analysis result at a subsequent third timing matches the horizontal frequency obtained as an analysis result at the second timing and a timing subsequent thereto. Furthermore, when the horizontal frequencies obtained at several timings after the third timing each match the horizontal frequency obtained at the second timing, the match determiner 1103 determines that the value of the item for which there has been a change in the signal information has matched multiple times. The number of times, like the multiple times, may be arbitrarily determined.

Moreover, the match determiner 1103 may determine that there is no longer any change in the video signal when the value of the item in which there has been a change has matched multiple times.

When the video signal no longer changes after it is determined that there has been a change on the basis of the determination result of the signal change determiner 1102, the discriminator 1104 discriminates the video signal input to its own electronic device (e.g., step S407 to be described below).

Moreover, if it determined that there has been no change in the video signal when the match determiner 1103 determines that there have been multiple matches, the discriminator 1104 discriminates the video signal input to its own electronic device.

Moreover, the discriminator 1104 identifies identification information according to the signal information of the video signal and outputs the identified identification information as a discrimination result. Here, identification information (hereinafter also referred to as a signal number) differing in accordance with the combination of various types of information included in the signal information is assigned in advance. Here, the signal information can be said to indicate the signal specifications. The signal number is uniquely determined in accordance with the signal specifications. Therefore, it is possible to identify the signal information from the signal number.

When the discriminator 1104 has discriminated the video signal, the notifier 1105 notifies each electronic device other than its own electronic device of the discrimination result and a mute instruction to mute the display of the video based on the video signal by transmitting the discrimination result and the mute instruction via the communication cable (e.g., step S408 to be described below).

The first muter 1106 mutes the display of the video based on the video signal of its own electronic device in accordance with the discrimination of the video signal by the discriminator 1104 (e.g., step S408 to be described below). A state of whether or not muting is in progress is indicated by a mute flag. When the mute flag is “1,” this indicates that the muting is in an OFF state (in which muting is not in progress). When the mute flag is “0,” this indicates that the muting is in an ON state (in which muting is in progress).

When the discriminator 1104 obtains a discrimination result, the first device configurator 1107 performs a configurating process according to a type of video signal in accordance with the discrimination result with respect to each device related to a video display process based on the video signal within its own electronic device on the basis of the discrimination result (e.g., step S410 to be described below).

When the device configurating process ends, the configurating completion notifier 1108 transmits a notification notifying that the configurating process has been completed to each electronic device other than its own electronic device (e.g., step S412 to be described below).

The first unmuter 1109 receives a notification notifying that the configurating process has been completed from each electronic device, performs a video unmuting process of its own electronic device (e.g., step S414 to be described below) when all device configurating processes of the plurality of electronic devices including its own electronic device have been completed (e.g., step S413-YES to be described below), and causes the display device to display the video based on the video signal.

Subsequently, the second functional unit 110B has a mute notification determiner 1113, a mute processor 1114, a discrimination result determiner 1115, a second device configurator 1116, a second configurating completion notifier 1117, and a second unmuter 1118.

The mute notification determiner 1113 determines whether or not a mute notification for muting the display of a video based on a video signal has been received from any electronic device other than its own electronic device (e.g., step S402 to be described below).

Muting the display of the video is a state in which the video based on the video signal is not displayed. For example, even if a state in which playback of a video based on a video signal can be started is reached, playback is stopped without starting. Moreover, in the state in which the display of the video is muted, it is not necessary for the projector to project a video and the entire screen may be projected with a single color (e.g., black).

The mute processor 1114 performs a video muting process of muting the video display in accordance with the reception of a mute notification from any electronic device other than its own electronic device (e.g., step S403 to be described below).

The discrimination result determiner 1115 determines whether or not the discrimination result of the video signal has been received from any electronic device other than its own electronic device (e.g., step S404 to be described below).

The second device configurator 1116 performs a configurating process according to a type of video signal in accordance with the discrimination result received from the master electronic device with respect to each device related to a video display process based on the video signal within its own electronic device (e.g., step S410 to be described below) without performing a discrimination process of discriminating the video signal input to its own electronic device (e.g., step S407 to be described below) by receiving a discrimination result from the master electronic device among electronic devices other than its own electronic device.

When the device configurating process ends, the second configurating completion notifier 1117 transmits a notification notifying that the configurating process has been completed to each electronic device other than its own electronic device (e.g., step S412 to be described below).

The second unmuter 1118 receives the notifications indicating that the configurating process has been completed from each electronic device, performs a video unmuting process of its own electronic device (e.g., step S414 to be described below) when all device configurating processes of the plurality of electronic devices including its own electronic device have been completed (e.g., step S413-YES to be described below), and causes the display device to display the video based on the video signal.

The storage unit 1110 stores various types of information. The storage unit 1110 stores, for example, a signal table. FIG. 3 is a diagram showing an example of the signal table. The signal table is data in which signal numbers and signal information are associated with each other.

For example, signal number “0001” is associated with signal information such as horizontal frequency “f11” and vertical frequency “f21.”

Next, an operation of the projector when a process of outputting a video signal from the video signal supply device 102 to the distributor 103 is started will be described.

When a playback instruction is externally input to the video signal supply device 102, the video signal supply device 102 starts the output of a video signal to the distributor 103. When the output of the video signal starts, the distributor 103 detects that the input of the video signal has started via the HDMI (registered trademark) cable. Subsequently, the distributor 103 acquires an optimal resolution signal in the EDID information of the projector 110, converts the video signal input to the distributor 103 into a resolution according to the EDID information, and outputs the converted video signal to the projector 110.

Subsequently, the distributor 103 acquires an optimal resolution signal in the EDID information of the projector 111, converts the video signal input to the distributor 103 into a resolution according to the EDID information, and outputs the converted video signal to the projector 111.

Furthermore, the distributor 103 acquires an optimal resolution signal from the EDID information of the projector 112, converts the video signal input to the distributor 103 into a resolution according to the EDID information, and outputs the converted video signal to the projector 112.

Furthermore, the distributor 103 acquires an optimal resolution signal from the EDID information of the projector 113, converts the video signal input to the distributor 103 into a resolution according to the EDID information, and outputs the converted video signal to the projector 113.

In other words, the distributor 103 starts the output of video signals in the order of the projector 110, the projector 111, the projector 112, and the projector 113.

Subsequently, the projector 110, the projector 111, the projector 112, and the projector 113 perform various types of processes based on the video signal and project videos based on the video signals input from the distributor 103 onto the display areas (106, 107, 108, and 109) of the screen.

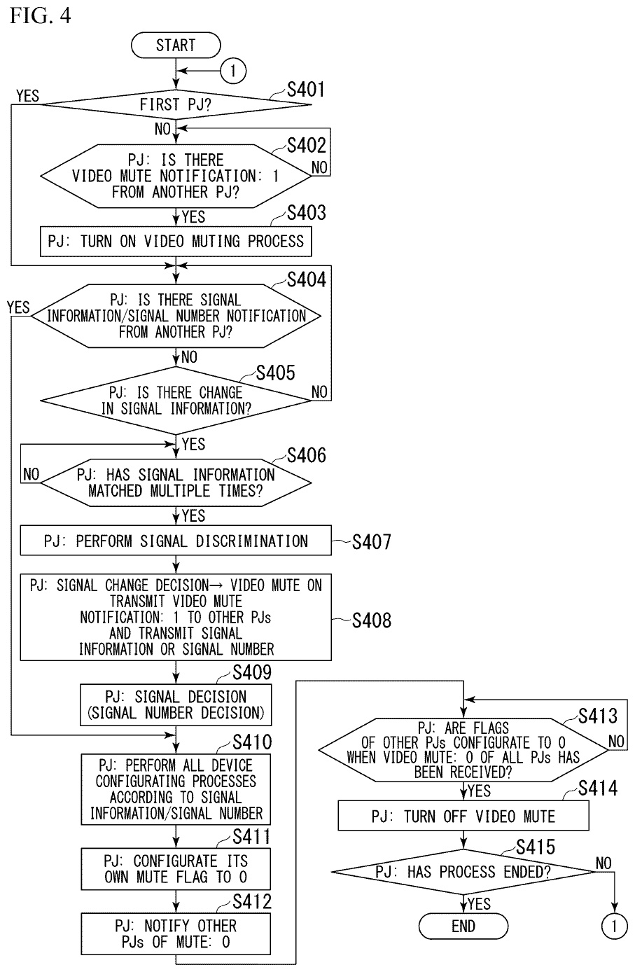

FIG. 4 is an explanatory flowchart of an operation of the projector 110.

Although various types of processes based on the video signal of the projector 110 will be described here, a process of a flow similar to that of FIG. 4 is performed with respect to the other projectors (111, 112, and 113).

In the initial state, the mute flags of the projectors 110, 111, 112, and 113 are all configurate to “1” and the muting of the video display is in an OFF state. Therefore, the video signal input from the video signal supply device 102 is projected onto the display area from each projector.

The control unit 1101 of the projector 110 determines whether or not the projector 110 is the first projector with reference to the number assigned to the terminal of the distributor 103 to which the projector 110 is connected (step S401).

Here, the control unit 1101 of the projector 110 determines that the projector 110 is the first projector because the projector 110 is connected to the first terminal 103a of the distributor 103 and is determined as the first projector (step S401-YES). Also, the control unit 1101 skips steps S402 and S403 and moves the process to step S404.

The discrimination result determiner 1115 of the projector 110 determines whether or not a discrimination result of discriminating the video signal has been received from another electronic device (any of the projectors (111, 112, and 113)) (step S404). At this time, while the video signal is input to the projector 110, the video signal is not input to the other projectors (111, 112, and 113). However, even if the video signal is input, the discrimination process on the video signal is not yet executed. Therefore, no discrimination results are received from the other projectors. Therefore, the discrimination result determiner 1115 of the projector 110 determines that no discrimination results have been received from the other projectors (111, 112, and 113) (step S404-NO), and the process proceeds to step S405.

Here, the discrimination process for obtaining the discrimination result of discriminating the video signal is performed by the discriminator 1104 of the first electronic device (here, for example, the projector 110) in step S407 to be described below.

Subsequently, the signal change determiner 1102 of the projector 110 determines whether or not there has been a change in the video signal input from the distributor 103 to its own electronic device (step S405). Here, the signal change determiner 1102 makes the determination of whether or not there has been a change in the video signal earlier than the determination of whether or not there has been a change in the video signal input to the slave projector by skipping the determination of whether or not a mute notification for muting the display of the video based on the video signal has been received from any electronic device other than its own electronic device (step S402) and the video muting process based on the determination result (step S403).

The signal change determiner 1102 of the projector 110 acquires signal information by analyzing the video signal. When there has been a change in the acquired signal information (step S405-YES), the process proceeds to step S406. When there has been no change in the signal information (step S405-NO), the process proceeds to step S404.

Here, for example, when a video signal is input from the distributor 103 to the projector 110 and the video signal supply device 102 or the distributor 103 starts the output of the video signal, if a transient phenomenon or the like occurs in the video signal supply device 102 or the distributor 103, a change may occur in at least one item (e.g., the horizontal resolution, the vertical frequency, or the like). In this way, because the video signal is not stable before a certain amount of time elapses from the start of the output of the video signal from the distributor 103, it is determined that there has been a change in the signal information.

When it is determined that there has been a change in the signal information, the match determiner 1103 of the projector 110 determines whether or not the signal information has matched multiple times from the time when the video signal is determined to have been changed (step S406).

Here, the video signal is stable when a certain amount of time has elapsed after the start of the output of the distributor 103 and no changes occur in the signal information. In step S405, the match determiner 1103 determines whether or not the signal information of the video signal obtained at the determination timing is the same as the signal information obtained previously every time the determination timing is reached from a timing at which it is determined that there has been a change in the video signal. When the signal information has not matched multiple times (step S406-NO), the match determiner 1103 executes step S406 again. When the signal information has matched multiple times (step S406-YES), the process proceeds to step S407.

If the signal information is determined to have matched multiple times, the discriminator 1104 identifies the video signal by identifying the signal number according to the signal information determined to match multiple times (step S407).

For example, the discriminator 1104 identifies signal information matching the value of each item included in the signal information determined to match multiple times with reference to the signal table stored in the storage unit 1110. Also, the discriminator 1104 can identify the signal number by reading the signal number corresponding to the identified signal information. For example, when the horizontal frequency and vertical frequency included in the signal information are “f12” and “f22,” respectively, and the values of the other items match, the signal number can be identified as “0002.”

Here, because there are many types of signal information, a certain amount of time may be required until signal information matching signal information obtained by searching for the signal table and analyzing a video signal is identified from a signal table. Here, the video signal is first input to the first projector 110 among the plurality of projectors. Therefore, the projector 110 can start the signal discrimination process of step S407 at an earlier stage than the other projectors. Moreover, because the other projectors do not perform the signal discrimination process as described below, there is no need to wait for the end of the signal discrimination process started at a timing later than that in the projector 110. Therefore, it is possible to reduce an increase in the length of time until the video is displayed on the display screen.

Moreover, the discriminator 1104 performs a signal discrimination process after it is determined that the signal information has matched multiple times. Therefore, the signal discrimination process can be performed from the time when the video signal has transitioned to a stable state. If the signal discrimination process is performed when a transient state occurs in the video signal in the step in which the output of the video signal has started, the accuracy of the signal discrimination process may decrease. However, the signal discrimination process can be performed from the time when the video signal has transitioned to a stable state. Therefore, it is possible to suppress a decrease in the discrimination accuracy of the signal discrimination process.

When the signal number is identified, the discriminator 1104 outputs the identified signal number as a discrimination result.

Subsequently, when the video signal is discriminated, the discriminator 1104 decides that there is no change in the signal information and outputs a result of deciding that there is no change in the signal information to the first muter 1106 and the notifier 1105.

When the discriminator 1104 notifies the first muter 1106 that the signal information has been decided, the first muter 1106 mutes the display of the video based on the video signal of the projector 110 on the basis of the decision. Also, the notifier 1105 notifies the other electronic devices (the projectors 111, 112, and 113) of the determination result (the signal number) and the mute instruction to mute the display of the video based on the video signal (step S408). Here, the projector 110 can mute the display of the video, while transmitting a mute instruction to the projectors 111, 112, and 113, such that the video can also be muted in the projectors 111, 112, and 113. Thus, it is possible to mute the video at the same timing in the respective projectors (110, 111, 112, and 113). Because the timing at which the video is muted can be aligned for each projector, the sense of discomfort felt by the user viewing the display screen can be reduced compared to a case where the timing at which the video is muted differs for each projector.

Here, the case where the video signal is no longer changed and the video is muted after the signal number of the video signal is decided in the processing of step S408 has been described. However, when it is determined that there has been a change in the signal information in step S405, the first muter 1106 may mute the video display of the projector 110 and the notifier 1105 may transmit an instruction to mute the video display to the other projectors (the projectors 111, 112, and 113).

Subsequently, when the determination result and the mute instruction are transmitted, the discriminator 1104 decides the signal number of the video signal (step S409).

When the signal number is decided, the first device configurator 1107 performs a configurating process according to the signal number of the video signal in accordance with a discrimination result with respect to various types of devices provided in the projector 110 (step S410). For example, because the signal number has been identified, it is possible to identify the signal specifications according to the signal number. because the signal specifications can be identified, values corresponding to video signal characteristics, such as a horizontal resolution, a vertical resolution, a horizontal frequency, a vertical frequency, and the like corresponding to the signal specifications, are determined. Thereby, the first device configurator 1107 configurates each device so that it can be driven to perform a display according to the horizontal resolution, the vertical resolution, the horizontal frequency, the vertical frequency, and the like corresponding to the signal specifications.

The first device configurator 1107 refers to the signal table, reads the signal specifications corresponding to the signal number, and configurates each device in accordance with the read signal specifications.

When the configurating process on the various types of devices is completed, the first configurating completion notifier 1108 configurates the mute flag assigned to the projector 110 itself from “1” to “0” (step S411). By configurating the mute flag to “0,” it is possible to indicate that the device configurating process has been completed and muting has been turned on.

The first configurating completion notifier 1108 transmits a notification notifying that the device configurating process has been completed to the other projectors (111, 112, and 113) via the communication cable (step S412). Here, the first configurating completion notifier 1108 may notify that the configurating process has been completed by transmitting an instruction to configurate the mute flag to “0.”

Subsequently, the first unmuter 1109 determines whether or not a completion notification notifying that the device configurating process has been completed has been received from the other projectors (111, 112, and 113) (step S413). When a completion notification has been received from the projector 111, the first unmuter 1109 configurates the mute flag assigned to the projector 111 among the mute flags stored in the projector 110 to “0.” The first unmuter 1109 configurates the mute flag assigned to the projector 112 among the mute flags stored in the projector 110 to “0” when the completion notification has been received from the projector 112 and the first unmuter 1109 configurates the mute flag assigned to the projector 113 among the mute flags stored in the projector 110 to “0” when the completion notification has been received from the projector 113.

When at least one of the mute flags stored in the projector 110 is “1,” the first unmuter 1109 determines that there is a projector for which the device configurating process has not been completed (step S413-NO) and executes the processing of step S413 again when a certain wait time has elapsed.

On the other hand, if all of the mute flags stored in the projector 110 are “0,” the first unmuter 1109 determines that the device configurating process has been completed for all of the plurality of electronic devices (the projectors 111, 112, and 113) including its own electronic device (the projector 110) (step S413-YES).

Also, the first unmuter 1109 performs an unmuting process on the video display of the projector 110 (step S414). Thereby, the projector 110 projects a video based on the video signal onto the display area 106 of the screen 105.

After a video display unmuting process is performed, the projector 110 determines whether or not to end the process (step S415). When an instruction to turn off the power or the like has been input, it is determined to end the process (step S415-YES) and the process ends. On the other hand, when it is determined not to end the process (step S415-NO), the projector 110 moves the process to step S401. In this case, if the projector 110 is determined to be the first projector in step S401, it is determined that a discrimination result has not been received from another projector in step S404, and it is determined that there is no change in the signal information of the video signal in step S405, the process proceeds to step S404. Here, because there is no change in the signal information of the video signal, the projector 110 can maintain the configurations for each device and continue the display of a video based on the video signal.

On the other hand, when there has been a change in the signal information of the video signal, the process proceeds to step S406 and the subsequent process is executed, such that each device configurating process is performed in accordance with the signal information of the video signal after the change and a video based on the video signal is displayed.

An example of a case where there has been a change in the video signal is a case where the video signal input from the video signal supply device 102 is switched to another video signal. Moreover, when there has been a change in the video signal, the video signal may be switched to another video signal by a switcher.

Here, the projector 110 waits for the reception of a notification of a mute flag of “0” from the other projectors (111, 112, and 113). For example, when the projector 111 among the other projectors completes the device configurating process, the mute flag assigned to the projector 111 among the mute flags stored in the projector 111 is rewritten to “0.” Furthermore, the projector 111 transmits a notification for configurating the mute flag to “0” to the projectors 110, 112, and 113. When the notification for configurating the mute flag to “0” is received from the projector 112, the projector 110 configurates the mute flag assigned to the projector 111 to “0.” The projectors 112 and 113 transmit notifications for configurating their mute flags to “0” to the other projectors when the device configurating process is completed.

In this way, because the unmuting process of the projector 110 is performed when all mute flags are updated to “0,” it is possible to unmute not only the projector 110 but also the other projectors (111, 112, and 113) after ascertaining that the device configurating process has been completed. Thereby, when the video signal supply device 102 has started the output of a video signal, a process of turning off the muting of the video display (the video unmuting process) in accordance with the timing of each projector is performed and therefore it is possible to display a video based on a video signal in accordance with a timing.

If the muting of the video display is turned off, the playback of the video signal also starts. Therefore, by adjusting the timing at which the muting of the video display is turned off, the timing at which the playback of the video based on the video signal starts can also be adjusted for each projector (110, 111, 112, or 113). Therefore, even if videos are projected individually from different projectors onto the respective display areas, the videos displayed on the screen 105 can be viewed with the playback timing synchronized as a whole.

Even if a timing at which the video display is unmuted does not match perfectly in each projector, the videos based on the video signal can be displayed at roughly the same timing. Here, because the display timing can be aligned in a range where the viewer does not perceive a difference between timings at which the videos based on the video signals are displayed, a sense of discomfort is unlikely to be felt.

Although the operation of the projector 110 has been described above, the operations of the projectors 111, 112, and 113 will be subsequently described. The operations of the projectors 111, 112, and 113 will also be described using the flowchart in FIG. 4. Here, although the operation of the projector 111 among the projectors 111, 112, and 113 will be described, the projectors 112 and 113 also operate in a similar process flow.

The projector 111 refers to the number assigned to the terminal of the distributor 103 to which the projector 111 is connected and determines whether or not it is the first projector (step S401).

Here, because the projector 111 is connected to the second terminal 103b of the distributor 103 and previously configured as the second projector, it is determined that the projector 111 is not the first projector (step S401-NO) and the process proceeds to step S402.

The mute notification determiner 1113 of the projector 111 determines whether or not a mute notification has been received from another projector (step S402). Here, the projector 110 executes the processing of step S408 before the timing at which the projector 111 executes the processing of step S402. Therefore, the video signal discrimination result and the mute instruction to mute the display of the video based on the video signal are received from the projector 110. Thereby, the mute notification determiner 1113 of the projector 111 determines that a mute instruction has been received (step S402-YES). On the other hand, if a mute instruction has not been received from another projector (step S402-NO), the mute notification determiner 1113 executes the processing of step S402 again when a certain wait time has elapsed.

The mute processor 1114 mutes the display of the video signal in accordance with the reception of the mute instruction from the projector 110 (step S403).

The discrimination result determiner 1115 of the projector 111 determines whether or not a discrimination result of discriminating the video signal has been received from the other electronic device (the projector 110) (step S404). Here, the projector 110 executes the processing of step S408 before the timing at which the projector 111 executes the processing of step S404. Therefore, the projector 111 receives the result of discriminating the video signal and a mute instruction to mute the display of the video based on the video signal from the projector 110. Thereby, the discrimination result determiner 1115 of the projector 111 determines that the mute instruction has been received (step S404-YES).

In accordance with the process moving to step S410, the second device configurator 1116 of the projector 111 performs a configurating process according to a type of video signal according to each device in accordance with the discrimination result received from the projector 110 without performing the discrimination process of step S407 in the projector 111 (step S410).

Here, if it is determined that a mute instruction has been received, the projector 111 can move the process to step S410. That is, projectors other than the projector 110 skip the processing of steps S405 to S409. Therefore, projectors other than the projector 110 do not need to wait for the stabilization of the video signal until the signal information matches multiple times in their own projectors in step S406 and only need to obtain the signal number from the projector 110 without performing the signal discrimination process of step S407. Therefore, when each projector belonging to the multi-display system performs a process of waiting for the signal information to match multiple times or a process of performing the signal discrimination process, even if the signal information match determination or signal discrimination process is completed in one projector, the waiting time will be prolonged because the process has not been completed in another projector. As a result, there is a problem in that the time until a video unmuting process is performed increases because the time required to wait for the completion of the device configurating process in all projectors is extended, which in turn delays the time until the video is displayed.

On the other hand, according to the above-described multi-display system S, instead of all projectors performing the signal information match determination or signal discrimination process, the first projector performs the process and notifies the other projectors of a result of the process. Thereby, it is possible to move to the configurating process for each device in step S410 without waiting for the completion of the signal information match determination or signal discrimination process in each of the other projectors. Therefore, it is possible to reduce an increase in the time until a video based on a video signal is displayed.

If the configurating process for the various types of devices is completed, the second configurating completion notifier 1117 of the projector 111 configurates the mute flag assigned to the projector 111 itself from “1” to “0” (step S411).

Moreover, the second configurating completion notifier 1117 of the projector 111 transmits a notification notifying that the device configurating process has been completed to the other projectors (110, 112, and 113) via the communication cable (step S412). Here, the first configurating completion notifier 1108 may transmit an instruction to configurate the mute flag to “0” to notify that the configurating process has been completed.

Subsequently, the second unmuter 1118 of the projector 111 determines whether or not a completion notification notifying that the device configurating process has been completed has been received from the other projectors (110, 112, and 113) (step S413). When the completion notification has been received from the projector 110, the second unmuter 1118 configurates the mute flag assigned to the projector 110 among the mute flags stored in the projector 111 to “0.” The second unmuter 1118 configurates the mute flag assigned to the projector 112 among the mute flags stored in the projector 110 to “0” when the completion notification has been received from the projector 112 and configurates the mute flag assigned to the projector 113 among the mute flags stored in the projector 110 to “0” when the completion notification has been received from the projector 113.

When at least one of the mute flags stored in the projector 111 is “1,” the second unmuter 1118 of the projector 111 determines that there is a projector for which the device configurating process has not been completed (step S413-NO) and executes the processing of step S413 again when a certain wait time has elapsed.

On the other hand, if all of the mute flags stored in the projector 111 are “0,” the second unmuter 1118 of the projector 111 determines that all device configurating processes of the plurality of electronic devices (the projectors 110, 112, and 113) including its own electronic device (the projector 111) have been completed (step S413-YES).

Also, the second unmuter 1118 performs a video display unmuting process of the projector 111 (step S414). Thereby, the projector 111 projects a video based on the video signal onto the display area 108 of the screen 105.

After the video display unmuting process is performed, the projector 111 determines whether or not to end a process (step S415), determines to end the process when an instruction to turn off the power or the like has been input (step S415-YES), and ends the process. On the other hand, when it is determined not to end the process (step S415-NO), the projector 111 moves the process to step S401. In this case, when it is determined that the projector 111 is not the first projector in step S401 and a mute instruction has not been received from another projector in step S402 (step S402-NO), the projector 111 executes the processing of step S402 again when a certain wait time has elapsed.

On the other hand, when a mute instruction has been received from another projector (step S402-YES), the projector 111 mutes the display of the video signal in accordance with the reception of the mute instruction from the projector 110 (step S403).

Also, the projector 111 determines whether or not a video signal discrimination result has been received from another projector. If the video signal discrimination result has not been received from another projector and there is no change in the video signal (step S405-NO), the projector 111 moves the process to step S404. Here, because there is no change in the signal information of the video signal, the projector 111 maintains the configurations for each device and continues the display of the video based on the video signal. When there is a change in the signal information of the video signal and the projector 111 has received a mute instruction or a video signal discrimination result from another projector, the projector 111 performs a process similar to the above-described process.

Moreover, when it is detected that there has been a signal change in step S405 (step S405-YES), the projector 111 can move the process to step S406 and perform a video signal match determination or video signal discrimination process, such that it is possible to notify the other projectors (110, 112, and 113) of the mute instruction and the discrimination result. In this case, the other projectors (110, 112, and 113) can receive the mute instruction and discrimination result received from the projector 111, mute the video display, and perform a configurating process for each device based on the discrimination result.

Although the operation of the projector 111 has been described above, the projector 112 also executes a process similar to that of the projector 112 while communicating with the other projectors (110, 111, and 113) as communication partners. Moreover, the projector 113 executes a process similar to that of the projector 112 while communicating with the other projectors (110, 111, and 112) as communication partners.

Moreover, in the above-described embodiment, notifications from one projector to the other projectors may be provided individually by designating the projector of the transmission destination or notifications may be provided simultaneously to all the other projectors.

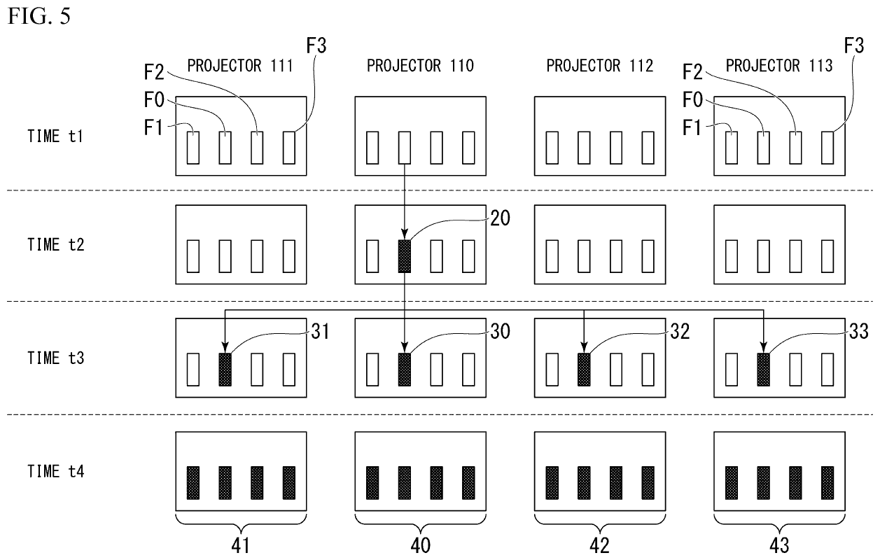

Next, FIG. 5 shows the state of the mute flags for the projectors 110 to 113.

In FIG. 5, the horizontal direction represents the state of the mute flags for the projectors 110 to 113 and the vertical direction represents the elapse of time. Here, it is shown that each projector can store four mute flags (flag F0, flag F1, flag F2, and flag F3). Flag F0 indicates the state of the mute flag assigned to the projector 110, flag F1 indicates the state of the mute flag assigned to the projector 111, flag F2 indicates the state of the mute flag assigned to the projector 112, and flag F3 indicates the state of the mute flag assigned to the projector 113. Such mute flags may be stored in the storage unit 1110.

Time t1 (a first row) represents the initial state, and each of flags F0 to F3 is “1” in all of the projectors 110 to 113. In the initial state, a video signal is not supplied from the distributor 103 and each device configurating process is not completed.

Also, when the projector 110 first executes the processing up to step S411, the flag assigned to the projector 110 among the mute flags stored within the projector 110 is configurate to “0” at time t2 (a second row) (reference sign 20). In this step, only the projector 110 indicates that the device configurating process has been completed.

Also, when a completion notification is transmitted from the projector 110 to the other projectors (111, 112, and 113) in step S412, the projectors 111, 112, and 113 configurate the flag assigned to the projector 110 to “0” on the basis of this notification at time t3 (reference signs 31, 32, and 33). Here, in the projector 110, the flag assigned to the projector 110 is maintained at “0.”

Thereafter, in each projector, each device configurating process based on the determination result output from the projector 110 is performed and a completion notification is transmitted, such that all of the flags of the respective projectors (110, 111, 112, and 113) are configurate to “0” at time t4 (reference signs 40, 41, 42, and 43). Thereby, the video display unmuting process is performed in each projector (110, 111, 112, or 113).

Moreover, in the above-described first embodiment, after EDID information is exchanged between the video signal supply device 102 and the distributor 103, EDID information is exchanged between the distributor 103 and the first projector and a video signal is supplied from the distributor 103 to the projector 110. Subsequently, the EDID information is exchanged between the distributor 103 and the second projector 111 and a video signal is supplied from the distributor 103 to the second projector 111. Subsequently, the exchange of the EDID information and the supply of the video signal are performed in the order of the distributor 103 and the third projector 112 and the distributor 103 and the fourth projector 113. Here, the first projector 110 can perform a video signal discrimination process in parallel with the other projectors (111, 112, and 113) exchanging EDID signals with the distributor 103 and supplying video signals and can notify the other projectors (111, 112, and 113) of the discrimination result. Thereby, the other projectors (111, 112, and 113) can acquire the video signal discrimination result from the projector 110 even at a timing before or during the exchange of EDID information with the distributor 103 and a timing before the discrimination process of the type of the video signal starts or the like. Thereby, even when a process that requires a certain amount of time, such as the exchange of EDID signals, is performed for each projector in turn, it is not necessary to perform the signal discrimination process in the second and subsequent projectors (111, 112, and 113) and wait for the discrimination result to be obtained by sharing the video signal discrimination result. Therefore, a period from the time when the video signal is supplied from the video signal supply device 102 to the time when the video display unmuting is performed can be shortened.

Moreover, in the above-described embodiment, the case where the projector 110 is configurate as the first projector by connecting to the first terminal 103a and the projector 111 connected to the second terminal 103b, the projector 112 connected to the third terminal 103c, and the projector 113 connected to the fourth terminal 103d are configurate as the second and subsequent projectors has been described. Here, the projector 110 may be connected to a terminal other than the first terminal 103a. For example, the projector 110 may be connected to any one of the second terminal 103b, the third terminal 103c, and the fourth terminal 103d. In this case the projector 110 can function as the second or subsequent projector by determining that the projector 110 is the second or subsequent projector and executing the process of the second functional unit 110B. Moreover, any one of the projectors 111, 112, and 113 may be connected to the first terminal 103a. In this case the projector connected to the first terminal 103a is determined to be the first projector and the first functional unit 110A executes the process, such that the projector can function as the first projector.

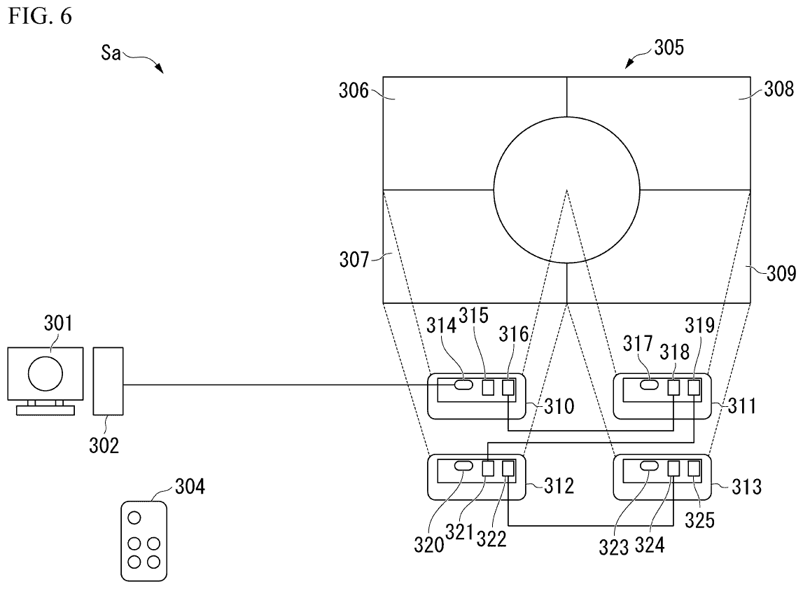

Next, FIG. 6 is a schematic diagram showing a configuration of a multi-display system Sa according to a second embodiment.

Although the distributor 103 is connected between the video signal supply device 102 and each projector and the plurality of projectors are each connected in parallel to this distributor 103 in the multi-display system S in FIG. 1, projectors are connected in a daisy chain without using a distributor in the multi-display system Sa shown in FIG. 6. In the multi-display system Sa, the projectors are connected in series. In other words, the projectors are connected in the daisy chain.

In the multi-display system Sa, a display device 301 is connected to an input terminal of a video signal supply device 302 via a communication cable. A video signal supply terminal of the video signal supply device 302 is connected to a connection terminal of the projector 310 via the communication cable. This communication cable may be an HDMI (registered trademark) cable. The video signal supply device 302 acquires EDID information from the projector 310 via the HDMI (registered trademark) cable and outputs a video signal according to the optimal resolution of the projector 310 to the projector 310 on the basis of an acquired EDID signal.

The remote controller 304 wirelessly transmits a control signal and a switching signal to each of the projectors (projectors 310, 311, 312, and 313). The control signal is a signal that turns on or off the power. The switching signal is a signal that switches the device from which the video signal is input.

The input terminal 315 of the projector 310 is not connected to other electronic devices (the projector 311, the projector 312, the projector 313, and the like).

An output terminal 316 of the projector 310 is connected to an input terminal 318 of the projector 311 via the communication cable. As this communication cable, the communication cable (e.g., the LAN cable) through which signals based on HDBaseT can be communicated can be used.

An output terminal 319 of the projector 311 is connected to the input terminal 321 of the projector 312 via the communication cable (e.g., the LAN cable).

An output terminal 322 of the projector 312 is connected to the input terminal 324 of the projector 313 via the communication cable (e.g., the LAN cable).

Although another projector can be connected to an output terminal 325 of the projector 313 via the communication cable (e.g., the LAN cable), it is not connected here.

Although the input terminal 317 of the projector 311, the input terminal 320 of the projector 312, and the input terminal 323 of the projector 313 can each be connected to a video signal supply device or a distributor via a communication cable (e.g., an HDMI (registered trademark) cable), nothing is connected here.

The projectors 310 and 311, the projectors 311 and 312, and the projectors 312 and 313 are each connected in series via the LAN cable and video signals are transmitted using signals based on HDBaseT. For example, the projector 310 converts the video signal input from the video signal supply device 302 via the HDMI (registered trademark) cable into an HDBaseT signal inside the projector 310, and outputs the HDBaseT signal from the output terminal 316, which is HDBaseT-OUT. Thereby, the video signal output from the projector 310 is input to the input terminal 317, which is the HDBaseT-IN of the projector 311. This video signal supply is also performed between the projectors 311 and 312 and between the projectors 312 and 313.

In addition, a notification of a discrimination result, a mute instruction, a notification notifying that the device configurating process has been completed, and the like are communicated between the respective projectors via the LAN cable, and therefore communication can be performed bidirectionally between the four projectors.

Here, each projector (310, 311, 312, or 313) is assigned a different number in advance. By recognizing the number, each projector identifies whether it is the first projector (the first electronic device) or the second or subsequent projector (the second electronic device, the third electronic device, or the fourth electronic device). Moreover, a corresponding relationship between the number and the projection target display area, i.e., the display area 106, the display area 107, the display area 108, or the display area 109, is predetermined and it is possible to determine a display area onto which the video is projected by recognizing the number.

Moreover, specifications of each projector are the same, the video signal supply device 302 acquires EDID information from the projector 310 and outputs a video signal with a resolution according to the EDID information to the projector 310, thereby making it possible to acquire video signals with the optimal resolution for the projectors 311, 312, and 313.

A screen 305 displays videos by projecting the videos from the respective projectors (the projector 310, the projector 311, the projector 312, and the projector 313).

The screen 305 is divided into two parts in the vertical direction and two parts in the horizontal direction. The screen 305 is divided into a total of four display areas, i.e., the display area 306, the display area 307, the display area 308, and the display area 309, which are installed adjacent to each other.

The display area 306 is assigned as the area onto which a video is projected by the projector 310. The display area 307 is assigned as the area onto which a video is projected by the projector 311. The display area 308 is assigned as the area onto which a video is projected by the projector 312. The display area 309 is assigned as the area onto which a video is projected by the projector 313.

In the above-described multi-display system Sa, the process of each of projectors 310, 311, 312, and 313 can be performed like the process shown in the flowchart shown in FIG. 4 described above.

Moreover, the case where the projector 310 is assigned in advance as the first projector and functions as the first projector has been described in the above-described embodiment. Moreover, the case where the projectors 311, 312, and 313 are assigned second to fourth numbers and function as the second and subsequent projectors has been described. However, the configurating process may be changed so that any one of the projectors 311, 312, and 313 is assigned as the first projector and the remaining projectors are assigned as the second and subsequent projectors. In this case, any one of the projectors 311, 312, and 313 assigned as the first projector can function as the first projector by determining that it is assigned as the first projector and executing the process of the first functional unit 110A. Moreover, when the projector 310 is assigned as any one of second to fourth projectors, the projector 310 can function as the second or subsequent projector by determining that it is assigned as the second or subsequent projector and executing the process of the second functional unit 110B.

According to the multi-display system S in the first embodiment and the multi-display system Sa in the second embodiment described above, it is possible to shorten the time from the input of the video signal to the video display unmuting of each projector by notifying the other projectors of signal information and a signal number from one projector.

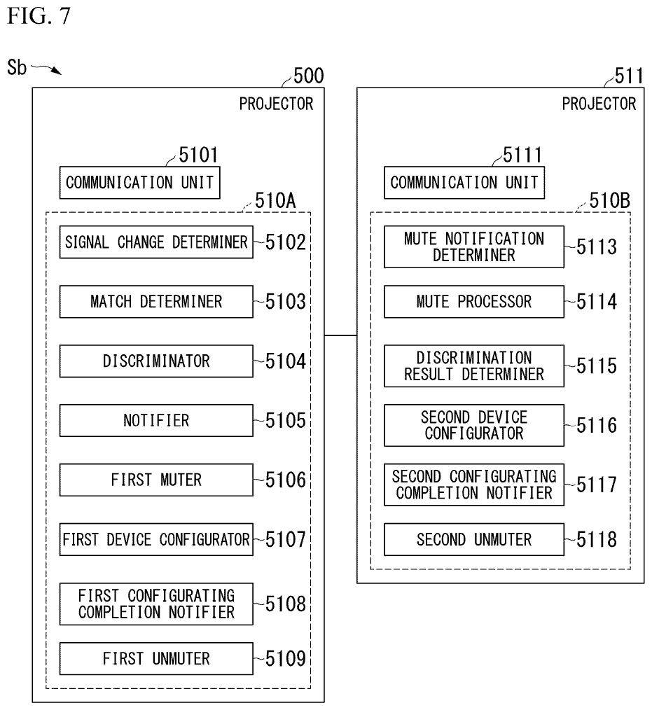

Next, FIG. 7 is a schematic diagram showing a configuration of a multi-display system Sb according to a third embodiment.

The multi-display system Sb includes a plurality of electronic devices that display videos based on video signals. The plurality of electronic devices include first to N^{th} electronic devices (N is a natural number of 2 or more). In this multi-display system Sb, a projector 500, which is a first electronic device, and a projector 511, which is a second electronic device, are communicatively connected via a communication cable. Although the multi-display system Sb having two projectors, i.e., the projector 500 and the projector 511, is shown, it may have three or more projectors. When there are three or more projectors, the third and subsequent projectors may be connected to the projector 500 via a communication cable so that they are in parallel with the projector 511. Moreover, the third and subsequent projectors may be connected in series to the projector 511. Moreover, a distributor may be connected to the video signal supply device, and the plurality of projectors may be connected to the distributor in parallel.

Moreover, a video signal is supplied to each of the plurality of electronic devices.

The projector 511 is an electronic device other than the first electronic device, and is a slave electronic device.

The projector 511 has a communication unit 5111 and a first functional unit 510A.

The first functional unit 510A has a mute notification determiner 5113, a mute processor 5114, a discrimination result determiner 5115, a second device configurator 5116, a second configurating completion notifier 5117, and a second unmuter 5118.

The communication unit 5111 is connected to an external device (e.g., a projector) via a communication cable and communicates with the connected device.

The mute notification determiner 5113 determines whether or not a mute notification for muting the display of a video based on a video signal has been received from any electronic device other than its own electronic device.

The mute processor 5114 performs a video muting process in accordance with the reception of a mute notification from any electronic device other than its own electronic device.

The discrimination result determiner 5115 determines whether or not a discrimination result of discriminating the video signal has been received from any electronic device other than its own electronic device.

The second device configurator 5116 performs a configurating process according to a type of video signal in accordance with the discrimination result received from the first electronic device with respect to each device related to a video display process based on the video signal input to its own slave electronic device without performing a discrimination process of discriminating the video signal input to its own slave electronic device by receiving the discrimination result from the first electronic device among electronic devices other than its own electronic device.

The second configurating completion notifier 5117 transmits a notification notifying that the configurating process has been completed to each electronic device other than its own electronic device if the device configurating process ends.

The second unmuter 5118 receives a notification from each electronic device indicating that the configurating process has been completed and performs the video unmuting process of the slave electronic device and causes the display device to display the video based on the video signal when all device configurating processes of the plurality of electronic devices including the slave electronic device have been completed.

The display device is, for example, a screen. When the video unmuting process is performed by the second unmuter 5118, the projector 511 displays the video based on the video signal by projecting the video onto the screen.

The projector 500 is the first electronic device and is the master electronic device.

The projector 500 has a communication unit 5101 and a second functional unit 510B.

The second functional unit 510B has a signal change determiner 5102, a match determiner 5103, a discriminator 5104, a notifier 5105, a first muter 5106, a first device configurator 5107, a first configurating completion notifier 5108, and a first unmuter 5109.

The communication unit 5101 is connected to an external device (e.g., a projector) via a communication cable and communicates with the connected device.

The signal change determiner 5102 makes the determination of whether or not there has been a change in the video signal input to the master electronic device earlier than the determination of whether or not there has been a change in the video signal input to the electronic device other than the master electronic device, without determining whether or not a mute notification for muting the display of the video based on the video signal has been received from any electronic device other than the master electronic device.

The discriminator 5104 discriminates the video signal input to the master electronic device when there is no change in the video signal after it is determined that there has been a change in the video signal on the basis of the determination result of the signal change determiner 5102.

When the video signal is discriminated by the discriminator 5104, the notifier 5105 notifies each electronic device other than its own electronic device of the discrimination result and a mute instruction to mute the display of the video based on the video signal.

The first muter 5106 mutes the display of the video based on the video signal of the master electronic device in accordance with the discrimination of the video signal by the discriminator 5104.

When the discriminator 5104 obtains a discrimination result, the first device configurator 5107 performs a configurating process in accordance with the type of the video signal for each device related to the display process of the video based on the video signal within the master electronic device on the basis of the discrimination result.

When the device configurating process ends, the first configurating completion notifier 5108 transmits a notification notifying that the configurating process is completed to each electronic device other than the master electronic device.

The first unmuter 5109 receives a notification notifying that the configurating process has been completed from each electronic device and performs the video unmuting process of its master electronic device and causes the display device to display the video based on the video signal when all device configurating processes of the plurality of electronic devices including the master electronic device have been completed.

The display device is, for example, a screen. If the first unmuter 5109 performs the video unmuting process, the projector 500 displays the video based on the video signal by projecting the video onto the screen.

In the first and second embodiments described above, the storage unit 1110 includes a storage medium, for example, a hard disk drive (HDD), a flash memory, an electrically erasable programmable read-only memory (EEPROM), a random access read/write memory (RAM), a read-only memory (ROM), or any combination of these storage media.

This storage unit 1110 can use, for example, a non-volatile memory.

Moreover, the communication unit 1100, the control unit 1101, the first functional unit 110A, and the second functional unit 110B in the first and second embodiments may include, for example, a processing device such as a central processing unit (CPU) or a dedicated electronic circuit. Moreover, the first functional unit 510A and the second functional unit 510B in the third embodiment may include, for example, a processing device such as a CPU or a dedicated electronic circuit.

Moreover, a program for implementing the functions of the communication unit 1100, the control unit 1101, the first functional unit 110A, and the second functional unit 110B in FIG. 2, a program for implementing the functions of the communication unit 5101 and the first functional unit 510A in FIG. 7, and a program for implementing the functions of the communication unit 5111 and the second functional unit 510B are recorded on a computer-readable recording medium, and the program recorded on the recording medium may be read into a computer system and executed to perform construction management. In addition, the “computer system” used here is assumed to include an operating system (OS) or hardware such as peripheral devices.

Moreover, the “computer system” is assumed to include a homepage provision environment (or display environment) if a World Wide Web (WWW) system is used.

Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client. Moreover, the above-described program may be a program for implementing some of the above-described functions. Further, the above-described function may be implemented in combination with a program already recorded on the computer system. Moreover, the above-described program may be stored in a predetermined server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope and spirit of the present invention.

### Reference Signs List

10 Video signal supply device
12 Projector
101 Display device
102 Video signal supply device
103 Distributor
103a First terminal
103b Second terminal
103c Third terminal
103d Fourth terminal
104 Remote controller
105 Screen
106 Display area
107 Display area
108 Display area
109 Display area
110 Projector
110A First functional unit
110B Second functional unit
111 Projector
112 Projector
113 Projector
114 Input terminal
115 Input terminal
116 Output terminal
117 Input terminal
118 Input terminal
119 Output terminal
120 Input terminal
121 Input terminal
122 Output terminal
123 Input terminal
124 Input terminal
125 Output terminal
301 Display device
302 Video signal supply device
304 Remote controller
305 Screen
306 Display area
307 Display area
308 Display area
309 Display area
310 Projector
311 Projector
312 Projector
313 Projector
315 Input terminal
316 Output terminal
317 Input terminal
318 Input terminal
319 Output terminal
320 Input terminal
321 Input terminal
322 Output terminal
323 Input terminal
324 Input terminal
325 Output terminal
500 Projector
510A First functional unit
510B Second functional unit
511 Projector
1100 Communication unit
1101 Control unit
1102 Signal change determiner
1103 Match determiner
1104 Discriminator
1105 Notifier
1106 First muter
1107 First device configurator
1108 First configurating completion notifier
1109 First unmuter
1110 Storage unit
1113 Mute notification determiner
1114 Mute processor
1115 Discrimination result determiner
1116 Second device configurator
1117 Second configurating completion notifier
1118 Second unmuter
1555 Device
2555 System
5101 Communication unit
5102 Signal change determiner
5103 Match determiner
5104 Discriminator
5105 Notifier
5106 First muter
5107 First device configurator
5108 First configurating completion notifier
5109 First unmuter
5111 Communication unit
5113 Mute notification determiner
5114 Mute processor
5115 Discrimination result determiner
5116 Second device configurator
5117 Second configurating completion notifier
5118 Second unmuter
S Multi-display system
Sa Multi-display system
Sb Multi-display system

What is claimed is:

1. A multi-display system including a plurality of electronic devices for displaying videos based on video signals,
wherein the plurality of electronic devices comprises first to N^{th} electronic devices, where N is a natural number of 2 or more, each of the first to N^{th} electronic devices being supplied with a video signal,
wherein each slave electronic device other than the first electronic device of the first to N^{th} electronic devices comprises:
a mute notification determiner that determines whether or not a mute notification for muting a display of a video based on the video signal has been received from any other slave electronic device than its own electronic device;
a mute processor that performs a video muting process in accordance with reception of a mute notification from the other slave electronic device than the its own electronic device;
a discrimination result determiner that determines whether or not a discrimination result of discriminating the video signal has been received from the other slave electronic device than the its own electronic device;
a second device configurator that performs, based on a type of the respective video signal in accordance with the discrimination result received from the first electronic device, a respective configurating process for configurating the electronic devices which are subject to a video display process based on the video signals within the its own electronic device, by receiving the discrimination result from the first electronic device, without performing a discrimination process of discriminating the video signal which has input to the its own electronic device from the other slave electronic device;
a second configurating completion notifier that transmits, when the respective configurating process ends, a notification notifying that the respective configurating process has been completed to the other electronic devices than the its own electronic device; and
a second unmuter that receives, from the electronic device, the notification notifying that the configurating process has been completed, that performs a video unmuting process of its own electronic device when all device configurating processes of the plurality of electronic devices including its own electronic device have been completed, and that causes a display device to display a video based on the video signal, and
wherein a master electronic device as the first electronic device includes
a signal change determiner configured to determine whether or not a video signal input to the its own electronic device has changed without determining whether or not a mute notification for muting a display of a video based on a video signal has been received from any electronic device other than its own electronic device;
a discriminator configured to discriminate the video signal input to the its own electronic device after it is determined that there has been a change in the video signal on the basis of a determination result of the signal change determiner;
a notifier configured to notify each electronic device other than its own electronic device of a discrimination result and a mute instruction to mute the display of the video based on the video signal when the discriminator has discriminated the video signal;
a first muter configured to mute a display of a video based on a video signal of its own electronic device in accordance with the discrimination of the video signal by the discriminator;
a first device configurator configured to perform a configurating process according to a type of the video signal in accordance with the discrimination result with respect to each device related to a video display process based on the video signal within the its own electronic device on the basis of a discrimination result when the discriminator obtains the discrimination result;
a first configurating completion notifier configured to transmit a notification notifying that a configurating process has been completed to each electronic device other than its own electronic device if a device configurating process ends; and
a first unmuter configured to receive the notification notifying that the configurating process has been completed from each electronic device, perform a video unmuting process of its own electronic device when all device configurating processes of the plurality of electronic devices including its own electronic device have been completed, and cause a display device to display a video based on the video signal.

2. The multi-display system according to claim 1,
wherein the signal change determiner of the master electronic device analyzes the video signal, the signal change determiner acquires signal information that is information about the video signal on the basis of an analysis result, and the signal change determiner determines that there has been a change in the video signal when there is a change in the acquired signal information,
wherein the master electronic device includes a match determiner configured to determine whether or not the signal information has matched multiple times after it is determined that there has been a change in the video signal on the basis of a determination result of the signal change determiner, and
wherein the discriminator of the master electronic device discriminates the video signal input to the its own electronic device when the match determiner determines that the signal information has matched multiple times.

3. The multi-display system according to claim 1, wherein the discriminator of the master electronic device identifies identification information corresponding to the signal information of the video signal and the discriminator of the master electronic device outputs the identified identification information as the discrimination result.

4. The multi-display system according to claim 1, wherein each of the first to N^{th} electronic devices is previously configured to be the first electronic device.

5. The multi-display system according to claim 1,
wherein each of the first to N^{th} electronic devices has both a function of the slave electronic device and a function of the master electronic device, and
wherein, if an electronic device of the first to N^{th} electronic devices is configured to be the first electronic device, the electronic device configured as the first electronic device performs the function of the master electronic device and the other electronic devices not configured to be the first electronic device serve performs the function of the slave electronic device.

6. A slave electronic device for use in a multi-display system comprising a plurality of electronic devices for displaying videos based on video signals,
wherein the plurality of electronic devices comprises first to N^{th} electronic devices, where N is a natural number of 2 or more, and a video signal is supplied to each electronic device of the first to N^{th} electronic devices, and
wherein slave electronic device other than the first electronic device comprises:
a mute notification determiner configured to determine whether or not a mute notification for muting a display of a video based on the video signal has been received from any electronic device other than the first electronic device;
a mute processor configured to perform a video muting process in accordance with the reception of the mute notification from any electronic device other than its own electronic device;
a discrimination result determiner configured to determine whether or not a discrimination result of discriminating the video signal has been received from any electronic device other than its own electronic device;
a second device configurator configured to perform a configurating process according to a type of the video signal in accordance with the discrimination result received from the first electronic device with respect to each device related to a video display process based on the video signal within its own slave electronic device without performing a discrimination process of discriminating the video signal input to the its own slave electronic device by receiving the discrimination result from the first electronic device among electronic devices other than the its own electronic device;
a second configurating completion notifier configured to transmit a notification notifying that the configurating process has been completed to each electronic device other than the its own electronic device if a device configurating process ends; and
a second unmuter configured to receive the notification notifying that the configurating process has been completed from each electronic device, to perform a video unmuting process of the its own slave electronic device when all device configurating processes of the plurality of electronic devices including the its own slave electronic device have been completed, and to cause a display device to display a video based on the video signal.

7. A master electronic device for use in a multi-display system comprising a plurality of electronic devices for displaying videos based on video signals,
wherein the plurality of electronic devices comprises first to N^{th} electronic devices, where N is a natural number of 2 or more, and a video signal is supplied to each electronic device of the first to N^{th} electronic devices, and
wherein the master electronic device as the first electronic device comprises:
a signal change determiner configured to determine whether or not a video signal input to its own master electronic device has changed without determining whether or not a mute notification for muting a display of a video based on a video signal has been received from any electronic device other than the its own electronic device;
a discriminator configured to discriminate the video signal input to the its own master electronic device after it is determined that there has been a change in the video signal on the basis of a determination result of the signal change determiner;
a notifier configured to notify each electronic device other than the its own electronic device of a discrimination result and a mute instruction to mute the display of the video based on the video signal when the discriminator has discriminated the video signal;
a first muter configured to mute a display of a video based on a video signal of the its own master electronic device in accordance with the discrimination of the video signal by the discriminator;
a first device configurator configured to perform a configurating process according to a type of the video signal in accordance with the discrimination result with respect to each device related to a video display process based on the video signal within the its own master electronic device on the basis of a discrimination result when the discriminator obtains the discrimination result;
a first configurating completion notifier configured to transmit a notification notifying that a configurating process has been completed to each electronic device other than its own electronic device if a device configurating process ends; and
a first unmuter configured to receive the notification notifying that the configurating process has been completed from each electronic device, to perform a video unmuting process of its own master electronic device when all device configurating processes of the plurality of electronic devices including its own master electronic device have been completed, and to cause a display device to display a video based on the video signal.
